(19) United States
(12) Patent Application Publication
(10) Pub. No.: US 2008/0020267 A1
(43) Pub. Date: Jan. 24, 2008

(54) Valve Regulated Lead-Acid Battery

(76) Inventors: Nobuyuki Aoki, Shizuoka (JP); Yoshie Suzuki, Aichi (JP)

Correspondence Address: MCDERMOTT WILL & EMERY LLP, 600 13TH STREET, NW, WASHINGTON, DC, 20005-3096, US

(21) Appl. No.: 11/664,698

(22) PCT Filed: Dec. 19, 2005
(86) PCT No.: PCT/JP05/23280

§ 371 Date: Apr. 5, 2007

(30) Foreign Application Priority Data
Dec. 22, 2004 (JP) 2004-370578

(51) Int. Cl. H01M 2/12

(52) U.S. Cl. 429/53

(57) ABSTRACT

A valve regulated lead-acid battery of the present invention includes a battery container provided with a plurality of cells, and a battery lid mounted over an opening of the battery container. The battery lid includes an exhaust chamber having an exhaust hole provided in the bottom and communicating with the cell, and an injection chamber having an injection hole provided in the bottom and communicating with the cell. The exhaust chamber includes a plate shaped valve body contacting with the bottom of the exhaust chamber and covering the exhaust hole, a sheet having elasticity and arranged on the valve body, and a top plate fixed to the battery lid and covering the sheet. The injection chamber includes a plug body for blocking the injection hole.

### TECHNICAL FIELD

The present invention relates to a valve regulated lead-acid battery and, in particular, to the structure of a battery lid.

### BACKGROUND ART

In recent years, valve regulated lead-acid batteries (sealed lead-acid batteries) including separators composed of glass fibers retaining electrolyte, and negative electrode plates for absorbing oxygen gas generated at the time of charging are widely used. In general, the lead-acid battery of this type includes a battery container having a plurality of cells, and a battery lid for covering and sealing an opening of the battery container. Each of the above-mentioned cells accommodates an electrode plate group composed of positive electrode plates and negative electrode plates arranged alternately with separators therebetween. Then, a safety valve provided in the battery lid is opened and closed to adjust the gas pressure in the cell.

FIG. 10 is an exploded perspective view showing the configuration of a battery lid in a prior art valve regulated lead-acid battery. As shown in FIG. 10, in the prior art battery lid 40, its upper surface is provided with an exhaust chamber 41, while the bottom of the exhaust chamber 41 is provided with a plurality of exhaust pipes 42 at positions respectively corresponding to cells of the battery container (not shown). The exhaust chamber 41 and each cell are communicated with each other trough each exhaust pipe 42. The exhaust pipe 42 is provided with a cap-shaped rubber valve 43 serving as a safety valve.

In order that the rubber valves 43 should not go away when gas generated in the cells is released to the outside of the cells through the exhaust pipes 42, a top plate 45 for covering the opening of the exhaust chamber 41 is arranged over the rubber valves 43. In FIG. 10, the rubber valves 43 and the top plate 45 are disassembled. However, at a positional relation indicated by dash-dotted lines, the rubber valves 43 are mounted on the exhaust pipes 42, while the top plate 45 is joined to the battery lid 40.

When the gas pressure in the cells is within a predetermined range, the rubber valves 43 close the exhaust pipes 42. Thus, the inside of the cells of the lead-acid battery provided with the battery lid 40 is maintained in a sealed state, and hence protected from the entering of atmospheric oxygen gas into the cell. When the amount of generated gas increases and the pressure in the cells rises, the rubber valves 43 are lifted up from the upper ends of the exhaust pipes 42 so that the sealing is opened. Accordingly, the gas in the cells is released to the outside through the gaps formed between the lifted rubber valves 43 and the exhaust pipes 42.

Here, since the exhaust pipes 42 are provided inside the exhaust chamber 41, the battery lid 40 need be designed in such a manner that a height for the exhaust pipes 42 should be ensured. Accordingly the reduction of the height of the battery lid 40 is restricted and hence the reduction of the size of the lead-acid battery.

In contrast, for example, Patent Document 1 discloses a valve regulated lead-acid battery employing a battery lid permitting height reduction. FIG. 11 is an exploded perspective view showing the configuration of the battery lid of this valve regulated lead-acid battery.

In the battery lid 50, its upper surface is provided with an exhaust chamber 51, while the bottom of the exhaust chamber 51 is provided with a plurality of exhaust holes 52 at positions respectively corresponding to cells of the battery container (not shown). The exhaust chamber 51 and each cell are communicated with each other through each exhaust hole 52. A valve body 53 composed of a rubber plate is arranged such as to contact with the bottom of the exhaust chamber 51, and thereby covers the exhaust holes 52.

Further, an elastic sheet 54 deformable in the thickness direction is arranged on the valve body 53, while a top plate 55 for covering an opening of the exhaust chamber 51 is arranged on the sheet 54 and joined to the battery lid 50. Then, the valve body 53 serves as safety valves.

As described here, the battery lid 50 proposed in Patent Document 1 has a structure in which the exhaust holes 52 provided in the bottom of the exhaust chamber 51 are covered by a plate shaped valve body, and the exhaust chamber 51 has no exhaust pipe shown in FIG. 10, which permits height reduction in the battery lid 50.

Meanwhile, in a fabrication process of a prior art valve regulated lead-acid battery, an electrode plate group including positive electrode plates, negative electrode plates, and separators was accommodated in each cell of a battery container. The battery lid was attached to the battery container, and then sulfuric acid serving as electrolyte was injected through the exhaust pipes or the exhaust holes of the battery lid.

Nevertheless, when the exhaust pipes or the exhaust holes are used also as injection ports as described above, the electrolyte may adhere around the exhaust pipes of the exhaust chamber or the exhaust holes in the bottom of the exhaust chamber at the time of injection. Then, when the electrolyte is adhered around the exhaust pipes or the exhaust holes, the sealing property can be degraded in the lead-acid battery. Further, since the safety valves are composed of rubber, the adhesion of electrolyte containing sulfuric acid easily degrades the safety valves. As a result, the valve opening and closing pressures of the safety valves become abnormal, so that the safety valves cannot operate normally.

If the valve opening pressure would rise abnormally, the internal pressure of the lead-acid battery could rise abnormally to cause deformation in the lead-acid battery. On the other hand, if the valve closing pressure would fall abnormally, the sealing property of the lead-acid battery could be degraded to cause oxidation of the negative electrode plates constituting the electrode plate group, and dissipation of the electrolyte out of the lead-acid battery.

Such a phenomenon could reduce rapidly the capacity of the lead-acid battery. Thus, in order that the reliability of the lead-acid battery should be maintained, at the time of injection, careful attention has been required such that the electrolyte should not adhere around the exhaust pipes or the exhaust holes.

In contrast, in the prior art lead-acid battery shown in FIG. 10 where the rubber valves 43 are mounted on the exhaust pipes 42, since the exhaust pipes 42 protrude from the bottom of the exhaust chamber 41, electrolyte adhered to the exhaust pipes 42 moves, by gravity, from the side parts of the exhaust pipes 42 to the base parts of the exhaust pipes 42 or the bottom of the exhaust chamber 41. Thus, the adhesion of electrolyte causes relatively little influence on the operation of the safety valves.

Nevertheless, in the prior art lead-acid battery shown in FIG. 11 where the exhaust holes 52 present in the bottom of the exhaust chamber 51 are covered by the valve body 53, electrolyte adhered around the exhaust holes 52 tends to remain intact, the adhesion of electrolyte causes larger influence on the operation of the safety valves, and hence causes difficulty in maintaining the reliability of the lead-acid battery.

Patent Document 1: Japanese Laid-Open Patent Publication No. Sho 62-147652

### DISCLOSURE OF INVENTION

### Problem that the Invention is to Solve

Thus, in order to solve the above-mentioned problems in the prior art, an object of the present invention is to provide a highly reliable valve regulated lead-acid battery which has a structure permitting height reduction so as to realize size reduction and can suppress adhesion of electrolyte in the periphery of exhaust holes of a battery lid.

### Means for Solving the Problem

In order to solve the above-mentioned problems, the present invention provides a valve regulated lead-acid battery including: an electrode plate group including positive electrode plates, negative electrode plates, separators each arranged between the positive electrode plate and the negative electrode plate, and electrolyte; a battery container including an opening and a plurality of cells each accommodating the electrode plate group; and a battery lid mounted over the opening; wherein

the battery lid includes an exhaust chamber and an injection chamber,

the exhaust chamber includes: an exhaust hole provided in a bottom of the exhaust chamber and in communication with said cell; a plate shaped valve body contacting with the bottom of the exhaust chamber and covering the exhaust hole; a sheet having elasticity and arranged on the valve body; and a top plate fixed to the battery lid and covering the sheet; and

the injection chamber includes: an injection hole provided in a bottom of the injection chamber and in communication with the cell; and a plug body for blocking said injection hole.

According to this configuration, in a battery lid, an injection chamber having an injection hole and an exhaust chamber having an exhaust hole are provided separately. Thus, when electrolyte is injected into the injection hole of the injection chamber, the electrolyte is prevented from adhering to the periphery of the exhaust hole of the exhaust chamber to ensure normal functioning of safety valve provided in the exhaust chamber. Further, since the exhaust hole in the bottom of the exhaust chamber is covered with a plate shaped valve body (serving as safety valve), a height of the battery lid can be reduced more reliably, and a size of the lead-acid battery can be reduced more reliably.

Preferably, the sheet is composed of a sponge body having continuous cell foams.

Preferably, oil is applied to a surface of the valve body that contacts with the bottom of the exhaust chamber.

Further, the injection hole preferably has a hollow pipe for communicating the injection chamber with the cell.

Further, in the lead-acid battery of the invention, preferably, a plurality of the injection chambers are arranged in correspondence to the plurality of cells, while the plug body is composed of a single member for collectively covering the plurality of injection chambers.

### EFFECTS OF THE INVENTION

According to the lead-acid battery of the present invention, in a battery lid, an injection chamber having an injection hole and an exhaust chamber having an exhaust hole are provided separately. Thus, when electrolyte is injected into the injection hole of the injection chamber, the electrolyte is prevented from adhering to the exhaust hole and the periphery thereof in the exhaust chamber to ensure normal functioning of safety valve provided in the exhaust chamber. Further, since the exhaust hole of the bottom of the exhaust chamber is covered with a plate shaped valve body (serving as safety valve), a height of the battery lid can be reduced more reliably, and a size of the lead-acid battery can be reduced more reliably. That is, according to the present invention, the lead-acid battery is more reliably provided in which size reduction and reliability improvement are achieved simultaneously.

### BRIEF DESCRIPTION OF DRAWING

FIG. 1 is a perspective view of an embodiment of a valve regulated lead-acid battery of the present invention.

FIG. 2 is a top view of a battery container 2 of a lead-acid battery 1 shown in FIG. 1 (that is, a lead-acid battery 1 of FIG. 1 is viewed in a direction indicated by an arrow X in a state that a battery lid 3 is removed).

FIG. 3 is an exploded perspective view of a battery lid 3 of a lead-acid battery 1 shown in FIG. 1.

FIG. 4 is a sectional view of a principal part of an exhaust chamber 11 of a battery lid 3 shown in FIG. 3 (that is, a sectional view taken along line A-A in FIG. 3).

FIG. 5 is a top view showing a principal part of a battery lid 3 shown in FIG. 3 (that is, a view in a direction indicated by an arrow X in a state that a valve body 13, a sheet 14, a top plate 15, and a plug body 25 are removed).

FIG. 6 is a sectional view of a principal part of injection chambers 21 of a battery lid 3 shown in FIG. 3 (that is, a sectional view taken along line B-B in FIG. 3).

FIG. 7 is a sectional view of an injection vessel 31 preferably used for a lead-acid battery 1 shown in FIG. 1.

FIG. 8 is a sectional view showing a state that an injection vessel 31 is mounted on injection chambers 21 of a lead-acid battery 1 shown in FIG. 1 (that is, a situation that electrolyte is injected).

FIG. 9 is a perspective view showing an upper end portion of a modification of a hollow pipe 23 which can be provided in an injection hole 22 of an embodiment of the present invention.

FIG. 10 is an exploded perspective view of a battery lid of a prior art valve regulated lead-acid battery.

FIG. 11 is an exploded perspective view of another battery lid of a prior art valve regulated lead-acid battery.

FIG. 12 is an exploded perspective view of a battery lid of a valve regulated lead-acid battery of Comparative Example 3.

### BEST MODE FOR CARRYING OUT THE INVENTION

An embodiment of a valve regulated lead-acid battery of the invention is described below with reference to the drawings. In the following description, specific dimensions are described for the members used in the battery. However, these dimensions can appropriately be set up in accordance with desired battery capacity or battery shape. Thus, the present invention is not limited to this specific embodiment.

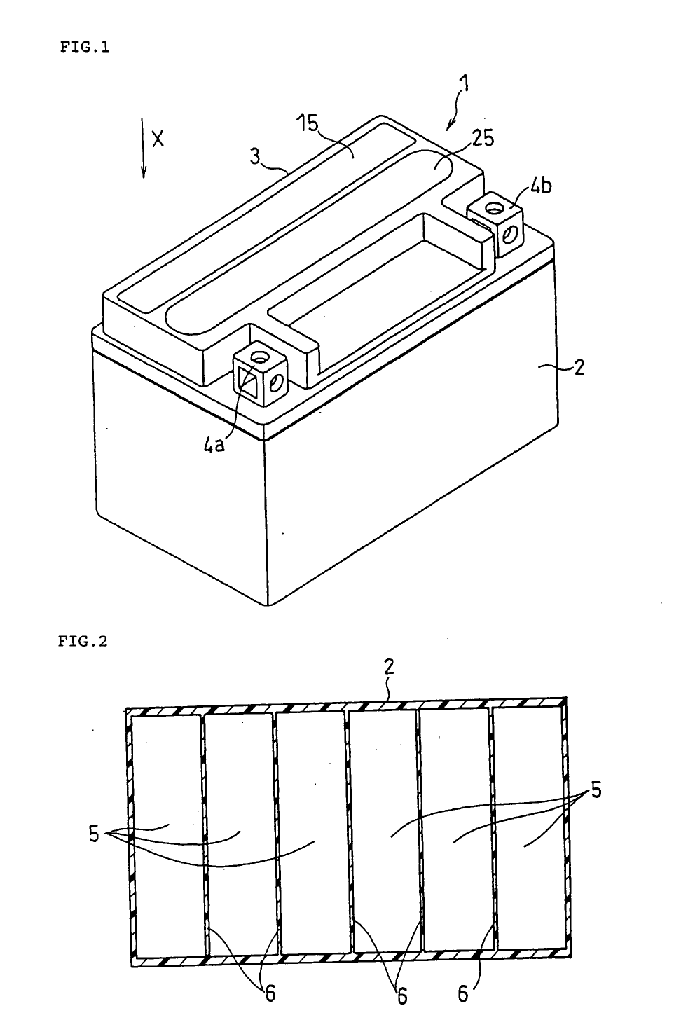

FIG. 1 is a perspective view of an embodiment of a valve regulated lead-acid battery of the invention. FIG. 2 is a top view of a battery container 2 of a lead-acid battery 1 shown in FIG. 1 (that is, a lead-acid battery 1 of FIG. 1 is viewed in a direction indicated by an arrow X in a state that a battery lid 3 is removed).

The lead-acid battery of FIG. 1 has the shape of a rectangular parallelepiped having a height of 93 mm, a width of 87 mm, and a length of 150 mm, for example, and has a nominal voltage to 12 V and a 10-hour rate capacity of 6 Ah, for example.

As shown in FIG. 2, in the lead-acid battery 1 of the present embodiment, a battery lid 3 provided with a positive electrode terminal 4a and a negative electrode terminal 4b is mounted over an opening of a battery container 2 having six cells 5, so that a sealed structure is formed.

The cells 5 are formed in line by dividing the battery container 2 with five partitions 6 as shown in FIG. 2. Each cell 5 accommodates one electrode plate group (not shown) including electrolyte. The electrode plate group is constructed, for example, from four positive electrode plates and five negative electrode plates arranged alternately together with separators each composed of a glass fiber mat or the like.

The employed positive electrode plates may be one of various types including conventionally well-known ones. In an example, each positive electrode plate is composed of a positive electrode grid fabricated from Pb—Ca based alloy and having a tab for current collection, and a positive electrode active material layer containing lead dioxide and retained by the positive electrode grid.

On the other hand, the employed negative electrode plates may be one of various types including conventionally well-known ones. In an example, each negative electrode plate is composed of a negative electrode grid fabricated from Pb—Ca based alloy and having a tab for current collection, and a negative electrode active material layer containing lead and retained by the negative electrode grid.

A positive electrode strap (not shown) is connected to a plurality of the tabs of the above-mentioned positive electrode plates included in the above-mentioned electrode plate group, while a negative electrode strap (not shown) is connected to a plurality of the tabs of the above-mentioned negative electrode plates included in the above-mentioned electrode plate group. These positive electrode strap and negative electrode strap may be conventionally well-known ones.

Then, a connection body connected to the positive electrode strap of one electrode plate group is connected to a connection body connected to the negative electrode strap of the other electrode plate group, via a through hole (not shown) provided in the partition 6, so that every two electrode plate groups adjacent to each other with a partition 6 in between, are electrically connected in series. As a whole, six electrode plate groups accommodated in the cells 5 are electrically connected in series.

Further, in the two electrode plate groups accommodated in the two end cells 5, a negative electrode pole (not shown) is provided in the negative electrode strap of one electrode plate group, and the negative electrode pole is connected to the negative electrode terminal 4b. Further, a positive electrode pole (not shown) is provided in the positive electrode strap of the other electrode plate group, and the positive electrode pole is connected to the positive electrode terminal 4a.

In FIG. 2, six cells 5 are arranged in line. However, in accordance with desired battery voltage or battery shape, the number and the arrangement of the cells 5, as well as the positions of the positive electrode terminal 4a and the negative electrode terminal 4b, may appropriately be designed.

An exhaust chamber 11 in the lead-acid battery 1 of the present embodiment is described below.

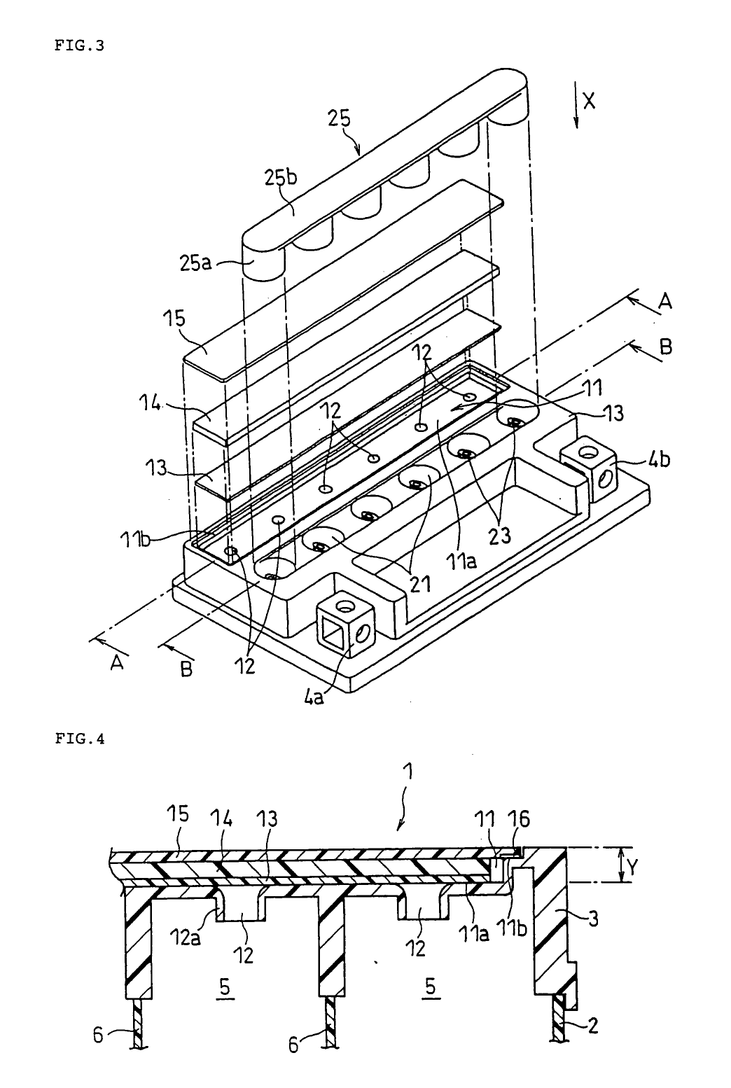

FIG. 3 is an exploded perspective view of a battery lid 3 of a lead-acid battery 1 shown in FIG. 1. As shown in FIG. 3, an exhaust chamber 11 formed in the shape of a longitudinal recess (for example, length: 135 mm, width: 15 mm, depth: 4 mm) is provided in the upper surface of the battery lid 3. In the bottom 11a (that is, the inner bottom surface of the recess) of the exhaust chamber 11, six exhaust holes 12 (having, for example, a diameter of 3 mm) each communicating with the cell 5 are provided in line at positions corresponding to the six cells 5 of the battery container 2.

Then, a plate shaped valve body 13 is arranged in contact with the bottom 11a of the exhaust chamber 11 with positional relation indicated by dash-dotted lines in FIG. 3, and thereby covers the exhaust holes 12. The valve body 13 covering the exhaust holes 12 serves as safety valves.

The valve body 13 need be provided with appropriate hardness and flexibility in order to closely contact with the bottom 11a of the exhaust chamber 11 and thereby achieve air tightness in the cells 5.

Thus, the valve body 13 is made of one of various materials having appropriate hardness and flexibility. For example, synthetic rubber such as styrene-butadiene rubber or neoprene rubber may be employed. In particular, neoprene rubber is preferably employed that has a hardness of 60-65 degrees according to the International Rubber Hardness Degree (IRHD).

The function of the valve body 13 is described below.

When the internal pressure of the cells 5 rises at the time of charging the battery 1, the valve body 13 having flexibility deforms upward elastically and thereby forms a gap, that is, a gas discharge path, between the valve body 13 and the bottom 11a of the exhaust chamber 11. Thus, the gas in the cells 5 is discharged to the outside via the exhaust chamber 11 (a valve opening operation). The internal pressure of the cell 5 at this time refers to a valve opening pressure.

Then, when the gas in the cells 5 has been discharged so that the internal pressure of the cells 5 has been reduced, the valve body 13 returns into the original plate shape and thereby closely contacts with the bottom 11a again. As a result, the gas discharge path is closed so that the air tightness of the cells 5 is restored (a valve closing operation). The internal pressure of the cell 5 at this time refers to a valve closing pressure.

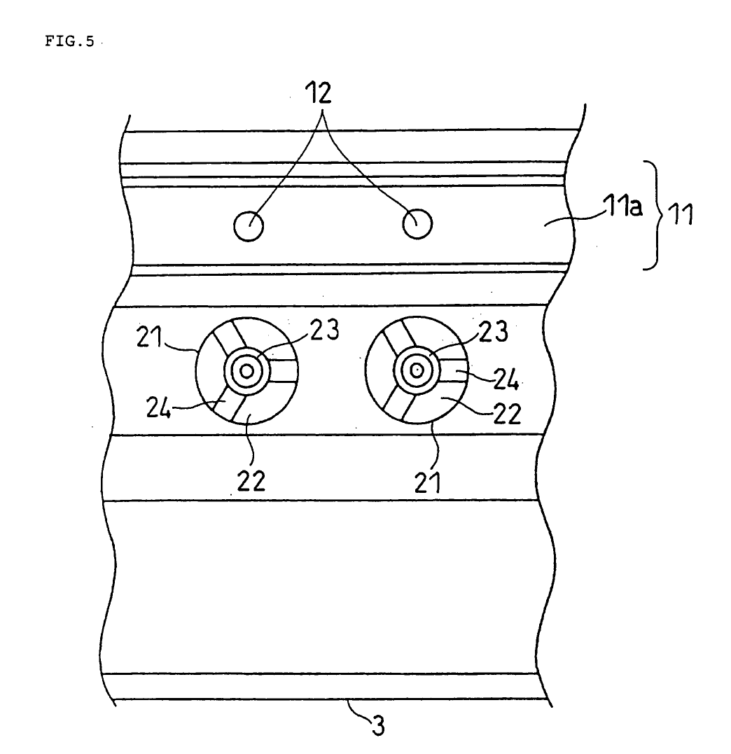

FIG. 4 is a sectional view of a principal part of an exhaust chamber 11 of a battery lid 3 shown in FIG. 3 (that is, a sectional view taken along line A-A in FIG. 3). Here, electrode plate groups accommodated in the cells 5 are omitted.

As shown in FIGS. 3 and 4, a sheet 14 having elasticity is overlaid and arranged on the valve body 13. Further, a top plate 15 is arranged on the sheet 14. The top plate 15 covers the opening of the exhaust chamber 11, and is joined to the battery lid 3. Here, the valve body 13 and the sheet 14 may simply be stacked together, or alternatively may be bonded and thereby integrated to each other.

As shown in FIG. 4, the sheet 14 having elasticity is arranged in the exhaust chamber 11, in a state pressed downward by the top plate 15 and thereby compressed in the thickness direction. The elastic force of the sheet 14 causes the valve body 13 to be pressed against and thereby closely contact with the bottom 11a of the exhaust chamber 11.

When this pressing force is increased, the valve opening pressure and the valve closing pressure rise. When the pressing force is reduced, the valve opening pressure and the valve closing pressure fall. Thus, by adjusting the pressing force of the sheet 14 pressing the valve body 13, the valve opening pressure and the valve closing pressure of the safety valves can be set up appropriately. The pressing force can appropriately be determined by adjusting, for example, Young's modulus and the thickness of the sheet 14 as well as the amount of thickness reduction at the time of compression. Further, the valve opening pressure and the valve closing pressure can be adjusted also by changing the thickness, the hardness, the flexibility, and the like of the valve body 13.

As for the material constructing the sheet 14, since the valve opening pressure and the valve closing pressure need be stable during the usage of the lead-acid battery 1, a material capable of maintaining the pressing force, that is, a material is capable of realizing a sheet 14 having good restorability from compression, is preferably used.

For example, a sponge body having continuous cell foams is preferably employed. For example, methylene copolymer of ethylene-propylene-diene (EPDM) or alternatively synthetic rubber such as neoprene that has a void ratio of 90% may be used appropriately.

Such a sponge body provided with continuous cell foams has good restorability from compression. Thus, in the case that a sheet 14 composed of the sponge body is used, at the time of charging the lead-acid battery 1, when the gas pressure in the cells 5 rises owing to the gas generated in the cells 5, the gas is discharged through the exhaust holes 12 to the exhaust chamber 11, and then the exhaust holes 12 are closed immediately after that.

Further, the gas discharged from the exhaust holes 12 permeates through the sponge body. Thus, the gas is rapidly released from the exhaust chamber 11.

When the cells 5 go into a reduced pressure state, the portions of the valve body 13 that oppose the exhaust holes 12 are suctioned toward the cells 5. At that time, if the valve body 13 were not pressed downward by the sheet 14, wrinkling could arise in the valve body 13. This could degrade the close contact of the valve body 13 with the bottom 11a of the exhaust chamber 11, or alternatively prevent reliable sealing between adjacent exhaust holes 12.

However, according to the present embodiment, since the valve body 13 is pressed downward by the sheet 14, the occurrence of wrinkling is suppressed in the valve body 13.

In the present embodiment, oil such as silicone oil is preferably applied to the contact surface of the valve body 13 contacting with the bottom 11a of the exhaust chamber 11. The oil spreads and seals between the bottom 11a of the exhaust chamber 11 and the valve body 13, and thereby improves the air tightness.

Further, the application of oil suppresses the sticking of the valve body 13 to the bottom 11a. This stabilizes the valve opening pressure and the valve closing pressure, and hence improves further the reliability in the function of the safety valves.

The top plate 15 arranged on the sheet 14 covers the opening of the exhaust chamber 11 with positional relation indicated by dash-dotted lines in FIG. 3, and is fixed to the battery lid 3. More specifically, a step 11b is provided in the periphery of the recess constituting the exhaust chamber 11, and the periphery of the top plate 15 is joined to this step 11b, so that the top plate 15 is joined to the battery lid 3.

Here, since the gas discharged from the cells 5 stays in the exhaust chamber 11, a plurality of protrusions (not shown) provided in the periphery of the top plate 15 are joined to the above-mentioned step 11b by ultrasonic welding or the like. By virtue of this, the top plate 15 is fixed to the battery lid 3 through the protrusions, while non-joined parts 16 are present between the battery lid 3 and the top plate 15. Thus, the gas discharged from the cells 5 to the exhaust chamber 11 is discharged from the exhaust chamber 11 to the outside via the non-joined parts 16.

In the present embodiment, the valve body 13 and the sheet 14 have substantially the same area, while the top plate 15 has an area larger than the valve body 13 and the sheet 14. Thus, when the valve body 13, the sheet 14, and the top plate 15 are stacked together, all of the periphery of the top plate 15 is exposed. Then, this periphery of the top plate 15 is joined to the step 11b of the exhaust chamber 11 as described above, so that the top plate 15 is joined to the battery lid 3.

Here, in the state that the top plate 15 is joined to the battery lid 3, the depth (Y in FIG. 4) of the recess constituting the exhaust chamber 11 is substantially the same as the sum of the thicknesses of the valve body 13, the sheet 14, and the top plate 15. In the state, it is preferred that the sheet 14 is compressed in the thickness direction. The elastic force of the sheet 14 causes the valve body 13 to be closely in contact with the bottom 11a, and thereby improves the air tightness of the exhaust hole 12. Further, as shown in FIG. 4, each exhaust hole 12 has a tube part 12a extending from the bottom 11a of the exhaust chamber 11 toward the cell 5.

Next, injection chambers 21 of the battery lid 3 are described below.

As shown in FIG. 3, in the upper surface of the battery lid 3, six injection chambers 21 are provided in line in correspondence to the six cells 5.

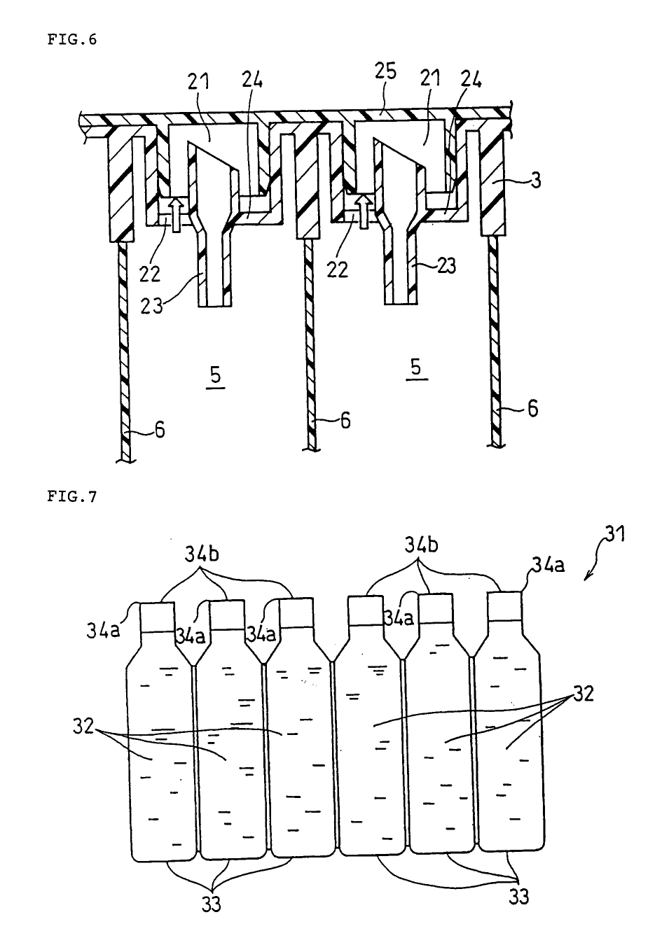

FIG. 5 is a top view showing a principal part of a battery lid 3 shown in FIG. 3 (that is, a view in a direction indicated by an arrow X in a state that a valve body 13, a sheet 14, a top plate 15, and a plug body 25 are removed). FIG. 6 is a sectional view of a principal part of injection chambers 21 of a battery lid 3 shown in FIG. 3 (that is, a sectional view taken along line B-B in FIG. 3). In FIG. 6, electrode plate groups accommodated in the cells 5 are omitted.

As shown in FIGS. 5 and 6, in the bottom of each injection chamber 21, an injection hole 22 is provided that is in communication with the cell 5 and used for injection of electrolyte into the cell 5. As shown in FIGS. 3 and 4, six injection chambers 21 are covered collectively with the single plug body 25, so that the injection holes 22 are closed.

Six plug bodies may be provided in correspondence to the six injection chambers 21, separately. However, from the view point of reduction in the number of components and the working time, the above-mentioned configuration is preferable that the six injection chambers are covered collectively by the single plug body 25. Here, merely the single injection chamber may be provided, while the single injection chamber may be provided with six injection holes formed in line in correspondence to the six cells.

The plug body 25 is preferably composed of synthetic rubber. When the plug body 25 composed of synthetic rubber is pressed into the injection chambers 21, the close contact is improved between the plug body 25 and the injection chambers 21. The plug body 25 comprises, in an integrated manner, six cylindrical parts 25a each formed to be fitted into each injection chamber 21 and thereby sealing the injection chamber 21, and a belt shaped part 25b connecting these cylindrical parts 25a. That is, the plug body 25 is constructed as a single member.

As described above, in the battery lid 3 of the present embodiment, the exhaust chamber 11 having the exhaust holes 12 and the injection chambers 21 each having the injection hole 22 are provided separately. Thus, at the time of injecting electrolyte, the electrolyte is prevented from adhering to the exhaust holes 12 and the periphery thereof in the bottom face of the exhaust chamber 11. This stabilizes the operation of the safety valves, and hence improves the reliability of the lead-acid battery 1.

Further, in the lead-acid battery 1 of the present embodiment employing the battery lid 3 where the plate shaped valve body 13 covers the exhaust holes 12, the height dimension of the battery lid can be reduced so that size reduction is achieved more easily in comparison with the prior art lead-acid battery, which employs a battery lid where cap-shaped rubber valves are mounted on exhaust pipes.

The injection chambers 21 of the present embodiment are described below in further detail.

In the inside of each injection hole 22, a hollow pipe 23 is provided an end of which opens toward the injection chamber 21 and the other end of which opens toward the cell 5. Support parts 24 are provided in a manner protruding from the inner side wall of the injection chamber 21 toward the injection hole 22 side. The hollow pipe 23 is supported and fixed by the support parts 24. That is, the hollow pipe 23 is arranged so as not to contact with the inner side wall of the injection hole 22.

As a result, two paths are ensured in the outside and the inside of the hollow pipe 23 in the injection hole 22, so that these two paths establish communication between the injection chamber 21 and the cell 5.

Here, described is the process of injecting electrolyte into the lead-acid battery 1 employing the above-mentioned battery lid 3 of the present embodiment.

In the injection process, an injection vessel 31 shown in FIG. 7 is used. FIG. 7 is a sectional view of an injection vessel 31 preferably used for a lead-acid battery 1 shown in FIG. 1. In the injection vessel 31, six sub-vessels 33 each having an opening 34a at the tip are arranged and integrated in line such that the openings 34a align in the same direction in correspondence to the injection chambers 21. The sub-vessels 33 are composed, for example, of synthetic resin having resistance to acid, such as polypropylene. The sub-vessels 33 accommodate electrolyte 32 to be injected into the cells 5. Then, the opening 34a of each sub-vessel 33 is sealed by a sheet shaped member 34b composed of a resin film having resistance to acid, or the like.

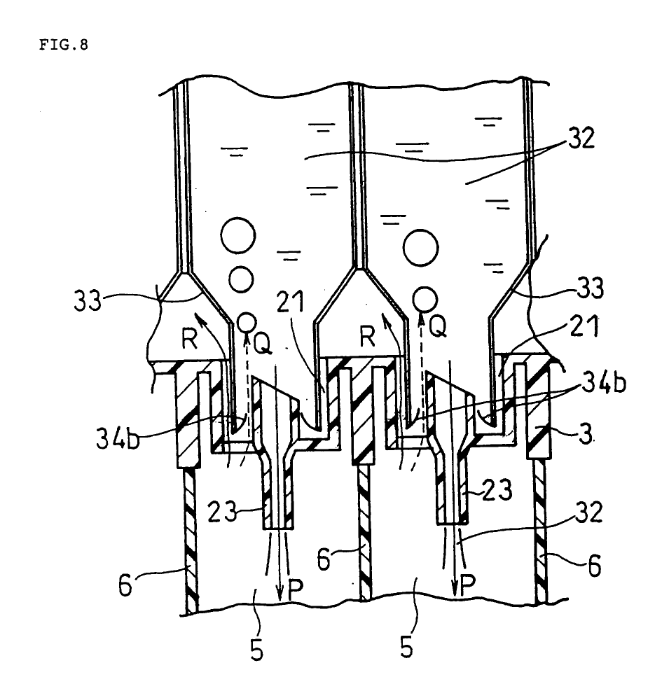

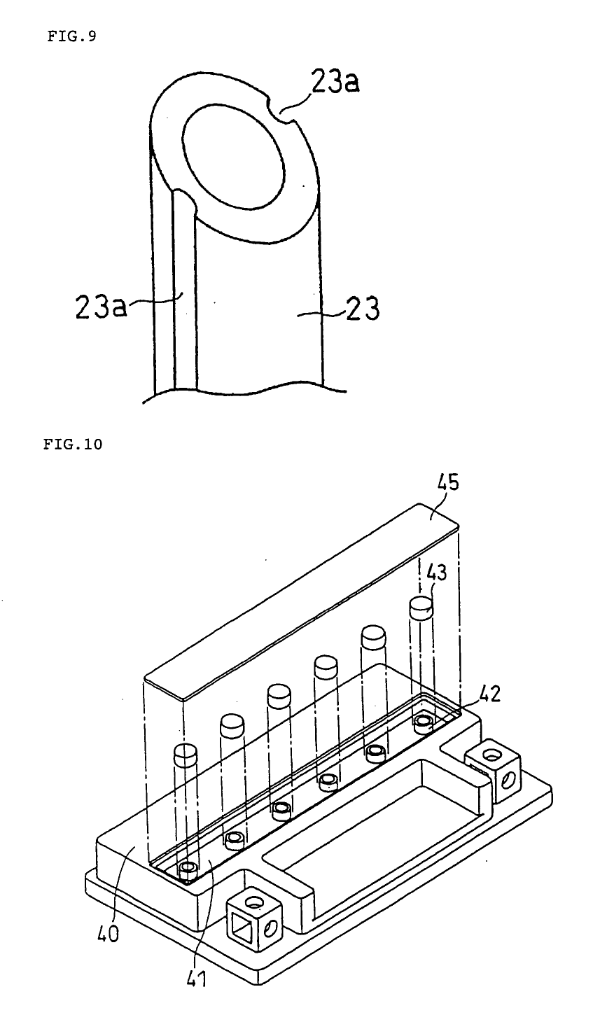

Here, a state that the electrolyte 32 in the injection vessel 31 is injected into the cells 5 is shown in FIG. 8. FIG. 8 is a sectional view showing a state that an injection vessel 31 is mounted on injection chambers 21 of a lead-acid battery 1 shown in FIG. 1 (that is, a situation that electrolyte is injected). This figure corresponds to a sectional view of a principal part of injection chambers 21 of a battery lid 3 shown in FIG. 3 (that is, a sectional view taken along line B-B in FIG. 3).

The injection vessel 31 is placed on the injection chambers 21 in such a manner that the openings 34a, which are located at the tips of the sub-vessels 33 and sealed by the sheet members 34b, correspond to the injection holes 22, respectively.

At that time, the sheet members 34b are broken by the tips on the injection chamber 21 side of the hollow pipes 23, so that the tips of the sub-vessels 33 become open. Then, the electrolyte 32 in the sub-vessels 33 is injected into the cells 5 through the inside of the hollow pipes 23 (the paths indicated by arrows P in FIG. 8).

Here, in order that the sheet shaped members 34b should be broken easily by the tips of the hollow pipes 23, the tips on the injection chamber 21 side of the hollow pipes 23 are inclined as shown in FIG. 6.

After the injection, the plug body 25 is attached to the injection chambers 21 so that the injection holes 22 are closed.

Further, in the present embodiment, space portions each formed between the outer surface of each hollow pipe 23 and the inner surface of each injection hole 22 constitute paths (see arrows in FIG. 6) for communicating the cells 5 with the injection chambers 21. At the time of injection, the air in the cells 5 moves to the injection chambers 21 through these paths, and then is released to the outside or alternatively moves into the sub-vessels 33.

That is, the air in the cells 5 is substituted by the electrolyte 32 (paths Q and paths R in FIG. 8), while the electrolyte 32 in the sub-vessels 33 is substituted by the air (paths Q in FIG. 8). Thus, the electrolyte 32 in the sub-vessels 33 rapidly moves into the cells 5.

If the air and the electrolyte 32 were not smoothly substituted with each other in the cells 5 so that the injection speed could exceed the speed of permeation of the electrolyte 32 into the electrode plate groups in the cells 5, the electrolyte 32 could overflow from the injection chambers 21 to the outside of the battery 1. Further, if the electrolyte 32 and the air were not smoothly substituted with each other in the sub-vessels 33, the speed of flowing out of the electrolyte 32 into the sub-vessels 33 would be reduced extremely, so that longer injection time would become necessary.

In contrast, according to the present embodiment, paths for communicating the injection chambers 21 with the cells 5 are respectively formed in the inner side and the outer side of the hollow pipes 23 in the injection holes 22 as described above. Thus, the air in the cell is smoothly substituted by the electrolyte 32 at the time of injection. This suppresses that the electrolyte 32 overflows from the injection chambers 21 at the time of injection, and reduces the injection time.

Further, as shown in FIG. 9, grooves 23a or cutouts (not shown) are preferably formed in the outer surface of each hollow pipe 23 from the injection chamber 21 toward the cell 5. FIG. 9 is a perspective view showing an upper end portion of a modification of a hollow pipe 23 which may be provided in an injection hole 22 of the present embodiment of the invention. According to this configuration, the electrolyte 32 in the sub-vessels 33 is more smoothly substituted by the air through the paths Q shown in FIG. 8.

The present invention is described below in further detail with reference to examples. However, the present invention is not limited to these specific examples.

### EXAMPLE

### Example 1

In this example, a lead-acid battery A of the present invention (12 V-6 Ah) was fabricated that employed the battery lid 3 having the structure shown in FIGS. 1-6 of the above-mentioned embodiment.

The plate shaped valve body 13 serves as safety valves was made with the use of neoprene rubber (having a thickness of 0.3 mm and an international rubber hardness of 60 degrees). The sheet 14 was fabricated from EPDM foam body (2.0 mm in thickness) having a void ratio of 90%. Further, the thickness of the sheet 14 was set to be 1.4 mm at the time of compression after the top plate 15 was fixed to the battery lid 3 in the battery fabrication. Thus, the sum of the thickness of the valve body 13 and the thickness of the sheet 14 was 1.7 mm at the time of battery fabrication. Furthermore, silicone oil was applied to the contact surface of the valve body 13 with the bottom 11a of the exhaust chamber 11.

In the fabrication of electrode plate groups, a positive electrode active material layer containing lead dioxide was retained by a positive electrode grid fabricated from Pb—Ca based alloy, so that each positive electrode plate was obtained. Further, a negative electrode active material layer containing lead was retained by a negative electrode grid fabricated from Pb—Ca based alloy, so that each negative electrode plate was obtained. Then, the positive electrode plates and the negative electrode plates obtained as described above were arranged alternately together with separators fabricated from glass fibers, so that each electrode plate group was fabricated.

At that time, four positive electrode plates and five negative electrode plates were incorporated.

The valve body 13, the sheet 14, and the top plate 15 were mounted on the exhaust chamber 11 of the battery lid 3. At that time, protrusions provided intermittently in the periphery of the top plate 15 were joined to the step 11b of the battery lid 3 by ultrasonic welding to fix the top plate 15 onto the battery lid 3. Since protrusions were intermittently provided, non-jointed parts 16 were present between the battery lid 3 and the top plate 15. Thus, the gas discharged from the cells 5 to the exhaust chamber 11 could be discharged from the exhaust chamber 11 to the outside via the non-jointed parts 16.

After that, the battery lid 3 was fit into the battery container 2. Then, using the injection vessel 31 and according to the above-mentioned method, dilute sulfuric acid (specific gravity: 1.320) serving as electrolyte was injected into the cells 5 through the injection holes 22 of the injection chambers 21. In this case, the time required in the injection was 20 seconds. After the injection, the plug body 25 was attached to the injection chambers 21.

### Comparative Example 1

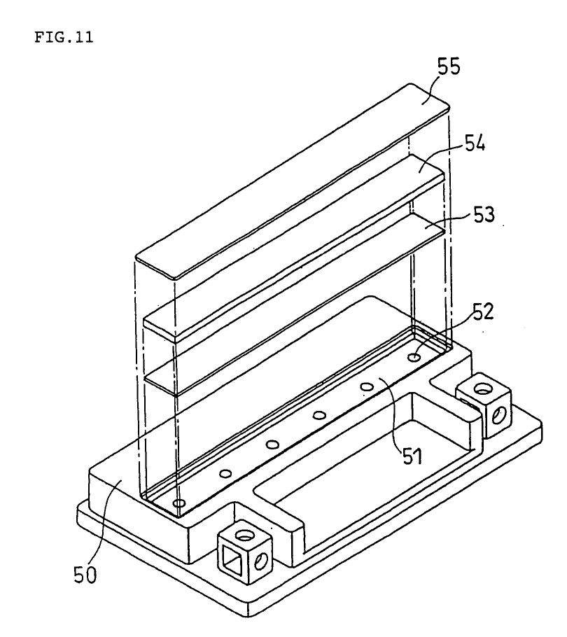

A lead-acid battery B of Comparative Example 1 was fabricated similarly to Example 1 except that a battery lid 40 employed had the structure of FIG. 10.

In contrast to the battery lid 3 employed in Example 1, in the battery lid 40, its upper surface was provided with an exhaust chamber 41 composed of a recess having a depth of 8.0 mm, while the bottom of the recess was provided with six exhaust pipes 42 (height: 5.0 mm, outer diameter: 6.0 mm, inner diameter: 3.0 mm) arranged in correspondence to the cells and serving also as injection holes.

After the above-mentioned battery lid 40 was fit into the battery container 2, an injection nozzle having a tip part of an outer diameter of 2.0 mm and an inner diameter of 1.5 mm was inserted into each exhaust pipe 42, so that electrolyte of the same type as in Example 1 was injected into each cell through the injection nozzle. In this case, the time required in the injection was 40 seconds. When the injection rate was increased further, the electrolyte overflowed through a gap between the outside of the injection nozzle and the exhaust pipe 42. Thus, the injection time was irreducible from that value.

Further, after the completion of injection, when the injection nozzle was removed from the exhaust pipe 42, drops of the electrolyte having remained in the injection nozzle tip adhered to the exhaust pipe 42 and the periphery thereof. Here, the degree of adhesion of the electrolyte was relatively small.

After that, cap-shaped rubber valves 43 (height: 4.0 mm, outer diameter: 7.0 mm, inner diameter: 5.5 mm, thickness of the top portion: 1.0 mm) were attached to each exhaust pipe 42. The rubber valves 43 were composed of the same material as the valve body 13 of Example 1. Further, silicone oil was applied to the surfaces of the rubber valves 43 which contact closely with the exhaust pipes 42. The top plate 45 for covering the rubber valves 43 was joined to the battery lid 40 by ultrasonic welding.

Here, since the cap-shaped rubber valves 43 were needed to be attached to the exhaust pipes 42, the height dimension measured from the base parts of the exhaust pipes 42 to the upper surfaces of the rubber valves 43 excluding the top plate 45 was the sum of the height 5.0 mm of the exhaust pipes 42 and the thickness 1.0 mm of the top portion of the rubber valves 43, which was equal to 6.0 mm.

### Comparative Example 2

A lead-acid battery C of Comparative Example 2 was fabricated similarly to Example 1 except that a battery lid 50 employed had the structure of FIG. 11.

In contrast to the battery lid 3 employed in Example 1, the battery lid 50 had a structure not employing the injection chambers 21 and the plug body 25. Thus, the exhaust holes 52 in the exhaust chamber 51 served also as the injection holes. The internal configuration of the exhaust chamber 51 was the same as in the exhaust chamber 11 of Example 1.

After the above-mentioned battery lid 50 was fit into the battery container 2, an injection nozzle having a tip part of an outer diameter of 2.0 mm and an inner diameter of 1.5 mm was inserted into each exhaust hole 52, so that electrolyte of the same type as in Example 1 was injected into each cell through the injection nozzle. In this case, the time required in the injection was 40 seconds. When the injection rate was increased further, the electrolyte overflowed through a gap between the injection nozzle and the exhaust hole 52. Thus, the injection time was irreducible from that value.

Further, after the completion of injection, when the injection nozzle was removed from the exhaust hole 52, drops of the electrolyte having remained in the injection nozzle tip adhered to the exhaust hole 52 and the periphery thereof. The degree of adhesion of the electrolyte in the periphery of the exhaust hole 52 was larger than in Comparative Example 1 where the exhaust pipe 42 had a certain height.

After that, the valve body 53 for covering the exhaust holes 52 was arranged in contact with the bottom of the exhaust chamber 51. Then, the sheet 54 was arranged on the valve body 53. Then, the top plate 55 was arranged on the sheet 54, and then joined to the battery lid 50 by ultrasonic welding, so that the lead-acid battery C was obtained.

### Comparative Example 3

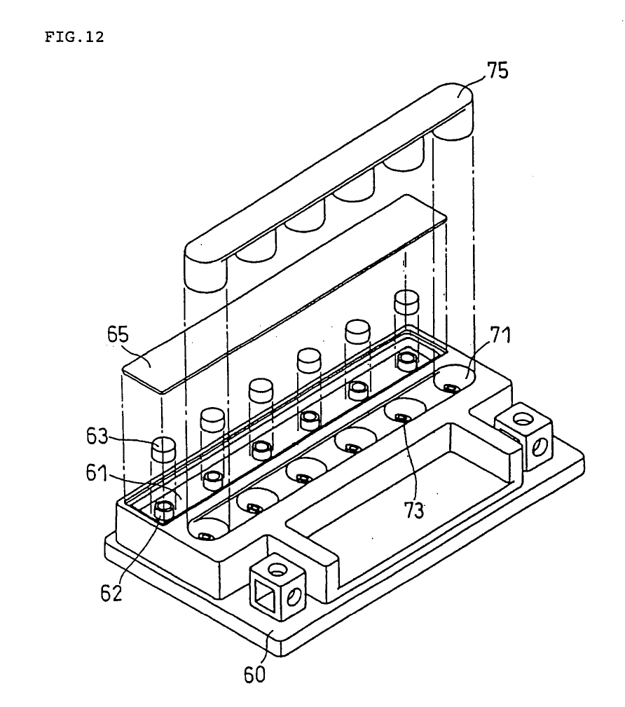

A lead-acid battery D of Comparative Example 3 was fabricated similarly to Example 1 except that a battery lid 60 employed had the structure of FIG. 12.

In contrast to the battery lid 3 employed in Example 1, the battery lid 60 had the structure of the inside of the exhaust chamber 41 in the battery lid 40 of Comparative Example 1 shown in FIG. 10.

First, cap-shaped rubber valves 63 were attached to the exhaust pipes 62 provided in the bottom face of the exhaust chamber 61. At that time, silicone oil was applied to the surfaces of the rubber valves 63 which contact closely with the exhaust pipes 62. The top plate 65 for covering the rubber valves 63 was joined to the battery lid 60 by ultrasonic welding.

The height dimension measured from the base parts of the exhaust pipes 62 to the upper surfaces of the rubber valves 63 excluding the top plate 65 was the sum of the height 5.0 mm of the exhaust pipes 62 and the thickness 1.0 mm of the top portion of the rubber valves 63, which was equal to 6.0 mm.

Further, according to the same method as Example 1, the same electrolyte as in Example 1 was injected into the cells through the injection chambers 71 having injection holes (not shown) and hollow pipes 73. In this case, the time required in the injection was 20 seconds. After the injection, the plug body 75 was attached to the injection chambers 71.

[Evaluation Test]

Three lead-acid batteries were fabricated for each of the types A-D described in Example 1 and Comparative Examples 1-3. Each lead-acid battery was charged at a constant current of 1.2 A for 1 hours.

Then, the valve opening pressure and the valve closing pressure of the safety valves were measured for each lead-acid battery by the following method. The penetration pore was provided in the side portion of the battery container corresponding to the cell adjacent the cell provided with the positive electrode terminal (that is, the second cell counted from the positive electrode terminal side). The air compressor was connected to the penetration pore via the tube. The internal pressure was measured by a pressure gauge provided between the air compressor and the penetration pore.

The internal pressure of the cell was increased by the air compressor. At that time, the internal pressure of the cell indicated the peak value. When the internal pressure of the cell reached to the peak value, the gas in the cell was discharged to the outside by the valve opening operation of the safety valve. Thus, the internal pressure of the cell did not increase beyond the peak value. The peak value of the internal pressure of the cell was decided to the value opening pressure.

Further, after the internal pressure reached to the peak value, the air compressor was stopped. Since the valve opening operation of the safety valve was performed, the internal pressure of the cell was decreased by the discharge of the gas. Then, when the internal pressure of the cell was decreased to reach to a certain value, the internal pressure of the cell was stopped to decrease by the valve closing operation of the safety valve, and the internal pressure of the cell became stable. The internal pressure of the cell in the stable state was decided to the value closing pressure.

The results are shown in Table 1.

After that, the process of discharging at a constant current of 2.5 A for 1 hour and then charging the battery at a current up to 2.5 A at a constant voltage of 14.4 V was repeated to perform cycle test. The life was defined as the time point that the discharge voltage reaches 10.5 V. Among the lead-acid batteries A-D, the battery C had the shortest cycle life. That is, the discharge voltage fell to 10.5 V at the 425th cycle so that the life was reached. Thus, the charge and discharge cycle test was performed until the 425th cycle for each of the lead-acid batteries A-D. After the cycle test, the valve opening pressure and the valve closing pressure of the safety valves were measured again similarly to the above-mentioned case. The results are shown in Table 1.

Table 1 shows also the amounts of change in the valve opening pressure and the valve closing pressure after the charge and discharge cycles relative to the valve opening pressure and the valve closing pressure before the charge and discharge cycles (that is, {valve opening pressure after the charge and discharge cycles—valve opening pressure before the charge and discharge cycles} and {valve closing pressure after the charge and discharge cycles—valve closing pressure before the charge and discharge cycles}).

TABLE 1

| | | | Valve pressure (kPa) | | | | | |
|---|---|---|---|---|---|---|---|---|
| | | | | | After charge | | Change before and | |
| | | | Before charge and | | and discharge | | after charge and | |
| | | | discharge cycles | | cycles | | discharge cycles | |
| | | | Valve | Valve | Valve | Valve | Valve | Valve |
| | | | opening | closing | opening | closing | opening | closing |
| | | | pressure | pressure | pressure | pressure | pressure | pressure |
| Ex. 1 | Lead- | 1 | 20.6 | 11.7 | 22.6 | 11.4 | 2.0 | −0.3 |
| | acid | 2 | 20.2 | 12.0 | 22.3 | 11.7 | 2.1 | −0.3 |
| | battery A | 3 | 20.3 | 11.6 | 21.6 | 11.5 | 1.3 | −0.1 |
| Comp. | Lead- | 1 | 20.4 | 12.0 | 28.3 | 12.7 | 7.9 | 0.7 |
| Ex. 1 | acid | 2 | 19.7 | 12.4 | 29.2 | 12.0 | 9.5 | −0.4 |
| | battery B | 3 | 20.8 | 12.0 | 30.5 | 11.1 | 9.7 | −0.9 |
| Comp. | Lead- | 1 | 20.7 | 11.5 | 38.0 | 7.6 | 17.3 | −3.9 |
| Ex. 2 | acid | 2 | 20.0 | 11.7 | 39.0 | 9.7 | 19.0 | −2.0 |
| | battery C | 3 | 19.6 | 12.1 | 43.3 | 8.7 | 23.7 | −3.4 |
| Comp. | Lead- | 1 | 20.8 | 11.7 | 26.7 | 11.2 | 5.9 | −0.5 |
| Ex. 3 | acid | 2 | 20.3 | 12.4 | 28.0 | 12.6 | 7.7 | 0.2 |
| | battery D | 3 | 20.4 | 11.6 | 26.0 | 12.1 | 5.6 | 0.5 |

All the lead-acid batteries A-D showed a tendency that the valve opening pressure rises in association with the repeating of the charge and discharge cycles. The lead-acid battery A of Example 1 had a smaller increase in the valve opening pressure before and after the cycle test than the lead-acid batteries B-D of Comparative Examples 1-3. Further, the lead-acid battery A had a smaller variation in the increase of the valve opening pressure among the batteries of the same specification, than the lead-acid batteries B-D. The increase of the valve opening pressure is generally caused by adhesion of the valve body with the bottom of the exhaust chamber. However, the increase of the valve opening pressure in the degree of magnitude observed in the lead-acid battery A does not affect the battery performance.

In comparison with the lead-acid batteries B-D of the comparative examples, the lead-acid battery A of Example 1 of the invention had more stable valve opening pressure and valve closing pressure in the charge and discharge cycles, and hence achieved higher reliability.

On the other hand, in the lead-acid battery C which had reached the life at an earlier stage in the charge and discharge cycles, the valve opening pressure rose sharply in comparison with the lead-acid batteries A, B, and D. Further, the lead-acid battery C had larger variations in the valve opening pressure and the valve closing pressure. This can be attributed to the fact that the valve body 13 has closely contacted with the bottom of the exhaust chamber 51 in a state that the electrolyte has been adhered around the exhaust holes 52.

Further, the lead-acid battery C had a larger decrease in the valve closing pressure before and after the charge and discharge cycles, than the batteries A, B, and D. This indicates that the short life in the lead-acid battery C was caused by the sharp fall in the valve closing pressure. That is, the sharp fall has caused atmospheric oxygen to enter into the cells and thereby degrade the negative electrode plates.

The mechanism having caused the valve closing pressure to fall sharply in the lead-acid battery C is described below.

When the valve body 53 sticks to the bottom of the exhaust chamber 51, the valve opening pressure temporarily rises abnormally. When the valve opening operation was performed in this state, at the time that the valve body 53 is separated from the bottom of the exhaust chamber 52, smoothness is degraded in the separated surfaces of the valve body 53 and the bottom of the exhaust chamber 51. This degrades the close contact of the valve body 53 with the bottom of the exhaust chamber 51.

The lead-acid battery B and the lead-acid battery D had a larger increase in the valve opening pressure than the lead-acid battery A. Further, the difference between the increases in the valve opening pressure between the lead-acid battery C and the lead-acid battery D was smaller than the difference between the increases in the valve opening pressure between the lead-acid battery A and the lead-acid battery C. As seen from this fact, when the configuration that the exhaust holes provided in the exhaust chamber bottom face are covered by a plate shaped valve body is compared with the configuration that cap-shaped rubber valves are attached to the exhaust pipes in the exhaust chamber, the difference whether an injection chamber having injection holes is provided separately from the exhaust chamber or not has large influence on the rise of the valve opening pressure associated with the repeating of the charge and discharge cycles.

In the lead-acid battery B and the lead-acid battery D, air tightness is maintained when each exhaust pipe is tightened by a restoring force of the cap-shaped rubber valve expanded by the exhaust pipe. Thus, the rubber valve operates in a state that a tensile force is applied always. On the other hand, in the lead-acid battery A and the lead-acid battery C, air tightness is maintained by the pressing force of the valve body and the elastic body arranged on the valve body. Thus, the valve body operates in a state that a compressive force is applied always. Such difference in the manner that the stress is applied to the safety valve is expected to partly account for the different behaviors of the valve opening pressure and the valve closing pressure of the safety valves between the lead-acid battery A and the lead-acid batteries B and D.

In the lead-acid battery A of Example 1 having a total thickness of 1.70 mm which is the sum of the thicknesses of the valve body and the sheet, height reduction in the battery lid and hence battery size reduction are easily achieved in comparison with the lead-acid battery B of Comparative Example 1 and the lead-acid battery D of Comparative Example 3 having a dimension of 6.00 mm which is measured from the base parts of the exhaust pipes to the upper surfaces of the rubber valves. Further, when the height of the battery is maintained at the same value, the amount of achieved reduction in the height of the battery lid (for example, 6.00 mm−1.70 mm=4.30 mm) is used for the increased height of the battery container, the height of the plates can be increased, and so can the capacity of the lead-acid battery. Further, since the lead-acid battery A of Example 1 of the present invention realizes a shorter injection time, productivity of the lead-acid battery is improved.

### INDUSTRIAL APPLICABILITY

A valve regulated lead-acid battery of the present invention permits size reduction and higher capacity, and has high reliability. This battery is suitably used as a power supply for various apparatuses such as motorcycles, backup units, and the like.

1. A valve regulated lead-acid battery comprising: an electrode plate group including positive electrode plates, negative electrode plates, separators each arranged between said positive electrode plate and said negative electrode plate, and electrolyte; a battery container including an opening and a plurality of cells each accommodating said electrode plate group; and a battery lid mounted over said opening; wherein
said battery lid includes an exhaust chamber and an injection chamber,
said exhaust chamber includes: an exhaust hole provided in a bottom of said exhaust chamber and in communication with said cell; a plate shaped valve body contacting with said bottom of said exhaust chamber and covering said exhaust hole; a sheet having elasticity and arranged on said valve body; and a top plate fixed to said battery lid and covering said sheet, and
said injection chamber includes: an injection hole provided in a bottom of said injection chamber and in communication with said cell; and a plug body for blocking said injection hole.

2. The valve regulated lead-acid battery in accordance with claim 1, wherein said sheet is composed of a sponge body having continuous cell foams.

3. The valve regulated lead-acid battery in accordance with claim 1, wherein oil is applied to a surface of said valve body that contacts with the bottom of said exhaust chamber.

4. The valve regulated lead-acid battery in accordance with claim 1, wherein said injection hole has a hollow pipe for communicating said injection chamber with said cell.

5. The valve regulated lead-acid battery in accordance with claim 1, wherein
a plurality of said injection chambers are arranged in correspondence to said plurality of cells, and
said plug body is composed of a single member for collectively covering said plurality of injection chambers.
